(19) United States
(12) Patent Application Publication
(10) Pub. No.: US 2003/0009475 A1
(43) Pub. Date: Jan. 9, 2003

(54) Information management dictionary, data retrieval server, database retrieval method, data duplicate method and computer product

(75) Inventors: Kazuo Kayamoto, Yokohama (JP); Hirofumi Okamoto, Yokohama (JP); Hideki Okamoto, Kawasaki (JP); Masaharu Koyabu, Kawasaki (JP); Ichiro Watanabe, Yokohama (JP); Toshikazu Sugita, Yokohama (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/098,460

(22) Filed: Mar. 18, 2002

(30) Foreign Application Priority Data
Jul. 5, 2001 (JP) 2001-205357

(51) Int. Cl. G06F 7/00

(52) U.S. Cl. 707/102

(57) ABSTRACT

Retrieving is conducted by employing table disclosure/non-disclosure information for managing a user who conducts a retrieving and disclosure or non-disclosure information of a table, and an information management dictionary having a disclosure condition for managing a user who conducts retrieving and each data item in the table. In addition, server information for managing information of another server is employed to conduct duplicating data or the information management dictionary.

### FIELD OF THE INVENTION

The present invention relates to a retrieval technique of an online database. More particularly this invention relates to a technique relevant to an OLAP (Online Analytical Processing multi-dimensional analysis) using data warehouses or data marts which accumulate a large amount of data.

### BACKGROUND OF THE INVENTION

In recent years, along with a use of an Internet technique with respect to a business market, an Internet business with an electronic commerce (EC) as a core has been widely conducted.

In the Internet business, contents of the business have become remarkably diversified, and hit products and firm's competitors successively change, so that it is important to accurately grasp the direction of the market and to perform a product planning which satisfies customers.

As one method of such methods, there is taken note of a method in which a data warehouse for accumulating a large amount of data is provided, and on the basis of information which is extracted therefrom, a strategic business decision making is carried out. The OLAP is known as a method for extraction and analysis of such information.

The OLAP means an online analysis processing, which is directed for various persons such as actual departments, divisions, or analysts, administrators, executives in a company conduct analyzing in each dimension. Therefore, the OLAP is generally called a multi-dimensional analysis processing in Japanese.

As described above, in the OLAP, many divisions and persons conduct analysis in each dimension so that a configuration is employed in which an information management dictionary defining how to handle a data structure and data is employed so that a user his/herself can freely conduct using information of the data.

The information management dictionary is directed for managing defining how a user utilizes database information. The managed information includes a scheme, a table, an attribute or a management point of data item, and the like. The information management dictionary has a portion of a common dictionary managing various information which an administrator has organized, and a portion of a personal dictionary managing information of a management point which an ordinary user has created.

The management point is directed for, when the OLAP is utilized, expressing a classifying method or aspects relevant to how to analyze data. The management point is classified into items such as WHEN, WHO, WHERE, WHAT, and WHY. In these items, for example, with respect to WHEN, various aspects such as annual, yearly, semiannual, semiyearly, monthly, weekly, daily, hourly can be designated as the management point. Similarly, WHO and other items also have various aspects. An aspect which is defined and changed by the administrator of the dictionary is call a common management point, and an aspect which is defined and changed by an ordinary user with his/her own aspect is called a personal management point.

In the OLAP, in many cases, a data mart is employed in addition to the data warehouse. The data warehouse is directed for accumulating a large amount of data in existing systems or basic business systems inside or outside the company so that an ordinary user can utilize the data as a database on the basis of the information management dictionary. An information system which utilizes information extracted from the data warehouse to make use of the strategic business decision making can be called the data warehouse.

On the contrary, the data mart is a database which is generally located at a lower level to the data warehouse and which is to be a subset of the data warehouse having data narrowed according to an utilizing purpose of a specific users or group, for example, by divisions, stored therein.

Therefore, with respect to a certain aspect, there is no difference between the data warehouse and the data mart, however, scales thereof are different from each other. Generally, in many cases, the data warehouse is provided in a companywide server and the data mart is provided in a division server.

FIG. 10 is a system configuration which is generally employed in the OLAP. In the drawing, numeral 101 is a company wide server, numeral 102 is a division server, numeral 103 is a companywide administrator for managing the companywide server, numeral 104 is a division administrator for managing each division server, and numeral 105 is a user using a database such as the data warehouse or the data mart.

The companywide server 101 comprises a data warehouse 111 which is a database having a large amount of data stored therein in a companywide scale, a companywide information management dictionary 112 which is used for conducting various retrievals, a companywide data mart distribution unit 113 which is used for distributing data contents to the division servers, a companywide management unit 114 which is used when the companywide administrator 103 manages the data warehouse 111, the companywide information management dictionary 112 or the like, and a companywide retrieval unit 115 which is used when the user 105 retrieves the data warehouse 111.

The division server 102 comprises a data mart 121 having data stored therein by divisions, a division information management dictionary 122 which is used for conducting various retrievals from the data mart 121, a division data mart distribution unit 123 which is used for distributing data contents to the companywide server 101 or the other division server 102, a division management unit 124 which is used when each division administrator 104 manages the data mart 121 or the division information management dictionary 122, and a division retrieval unit 125 which is used when each user 105 retrieves the data mart 121.

The companywide administrator 103 employs the companywide management unit 114 to conduct operation and management of the data warehouse 111 and the companywide information management dictionary 112. For example, a tool function is used to conduct definition and management of a way to handle a data structure such as a table, a scheme or the like or data which is shared in a companywide manner. The companywide data mart distribution unit 113 is employed to conduct duplicating necessary data from the data warehouse 111 to the data mart 121.

The division administrator 104 employs the division management unit 124 to conduct operation and management of the data mart 121 and the division information management dictionary 122. For example, the tool function is used to conduct definition and management of the way to handle a data structure such as a table, a scheme or the like or data which is shared in the divisions. The division data mart distribution unit 123 is used to conduct duplicating necessary data from the data mart 121 to the data warehouse 111 or the other data mart 121.

The user 5 can employ the retrieval unit 115 or 125 to conduct retrieving the data warehouse 111 or the data mart 121 on the basis of the companywide information management dictionary 112 or the division information management dictionary 122. At this time, the user employs a GUI (Graphical User Interface) which is displayed on a display device of his/her own terminal to conduct selecting a retrieval condition.

The companywide information management dictionary 112 or the division information management dictionary 122 which is used for utilizing the data warehouse 111 or the data mart 121 is provided by companies or by divisions. Therefore, even if some departments exist in one division, the same (companywide or division) information management dictionary is used so that the user finds an attribute, a management point and the like of data items for other departments in the division which are originally unnecessary.

The OLAP has many items to be utilized as compared with a general database retrieval, in some case, has several thousands of items. Therefore, the user has been hard to select the necessary items even by using the GUI.

In order to avoid the above problem, it is considered that the division information management dictionary 122 is provided by departments. However, though, in the division, many departments handle the common data as a retrieval object, these departments individually need many division information management dictionaries 122, which results in an increase of a management cost and which makes it difficult to manage by the division administrators, thereby which is not practicable.

It is desired that, according to the contents of the database, all the contents contained in the same table is not disclosed and specific data is disclosed to only a specific department. However, a conventional companywide information management dictionary or division information management dictionary cannot cope with such method of use.

Furthermore, the conventional dictionary has not cope with creating and updating the division information management dictionary from the companywide information management dictionary, or duplicating a part of the information management dictionary for a specific division or user, or bidirectionally duplicating the contents from the division information management dictionary to the companywide information management dictionary.

### SUMMARY OF THE INVENTION

The information management dictionary according to one aspect of the present invention is configured to have a table disclosure/non-disclosure information for managing a user who conducts retrieving and disclosed or non-disclosed information of a table, and a table disclosure condition for managing a disclosure condition of a user who conducts retrieving and each data in the table. On the basis of the table disclosure/non-disclosure information, only information disclosed to a user is displayed for the user to cause the user to select the information, and further to retrieve the database on the basis of the table disclosure condition.

Furthermore, there is configured such that the information management dictionary has server information for managing information of another server, and causes an administrator to select a table to be duplicated on the basis of the contents of the table disclosure/non-disclosure information to acquire the server information of the duplicated destination from the server information, and to refer to a table disclosure condition for managing a disclosure condition of a user stored in the server and each data item in a table to acquire data of the table disclosed to the user and to transmit the data with the table structure to the another server which are each to be the duplicated destination.

Other objects and features of this invention will become apparent from the following description with reference to the accompanying drawings.

### BRIEF DESCRIPTION OF THE DRAWINGS

FIG. 1 is a view which shows a network system configuration which is used for an embodiment according to the present invention,

FIG. 2 is an example of a table which is stored in a data mart,

FIG. 3 is an example of various information which is stored in a division information management dictionary,

FIG. 4 is a flowchart for explaining a retrieval method of the data mart,

FIG. 5 is a display example of a retrieval designation screen,

FIGS. 6A and 6B are display examples of a retrieval result,

FIG. 7 is a flow chart for explaining a duplicate method (part 1),

FIG. 8 is a flow chart for explaining the duplicate method (part 2),

FIGS. 9A and 9B are views which show a display example of a table and disclosure/non-disclosure information, and a display/selection example of a duplicated destination server, respectively, and

FIG. 10 is a view which shows a network system configuration which is used in a prior art.

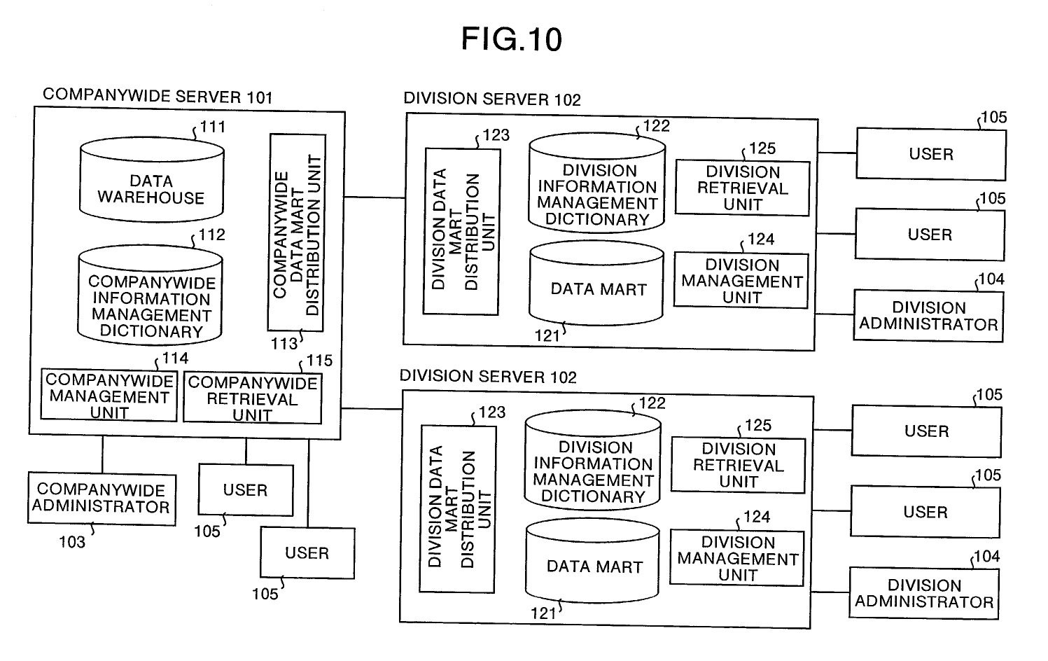

### DETAILED DESCRIPTIONS

An embodiment of the present invention will be explained below while referring to the accompanying drawings.

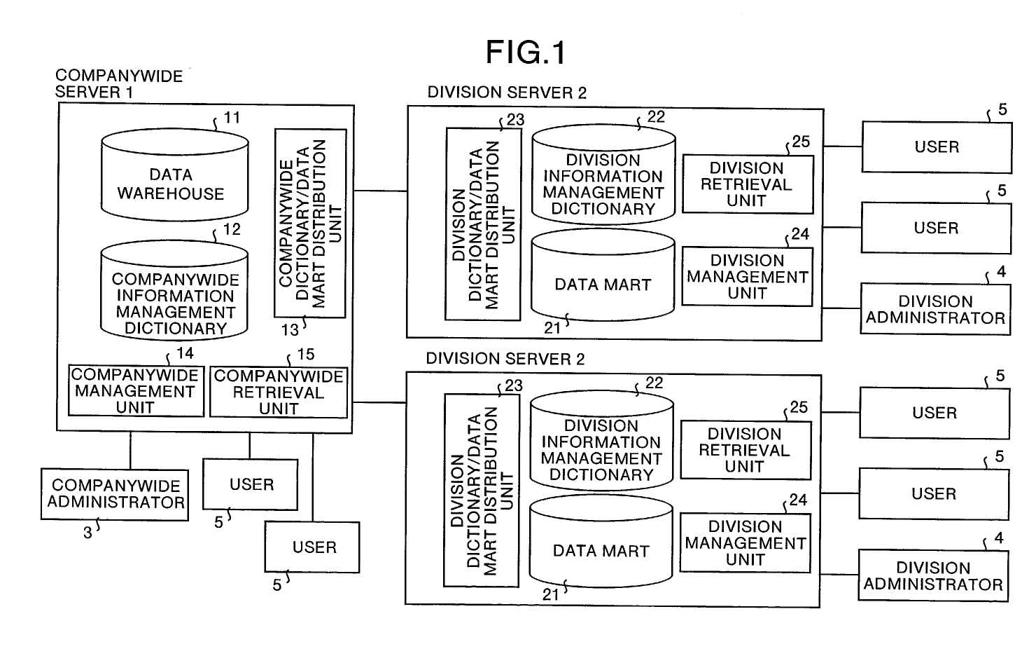

FIG. 1 is a system configuration which is used for the embodiment according to the present invention. In the drawing, numeral 1 is a companywide server, numeral 2 is a division sever, numeral 3 is a companywide administrator for managing the companywide server, numeral 4 is a division administrator for managing each division server, and numeral 5 is a user which uses a database such as a data warehouse, a data mart or the like.

The companywide server 1 comprises a data warehouse 11 which is a database having a large amount of data stored therein with a companywide scale, a companywide information management dictionary 12 which is used for conducting various retrievals, a companywide dictionary/data mart distribution unit 13 which is used for distributing a dictionary or data contents to the division server 2 or acquiring the dictionary or the data contents from the division server 2, a companywide management unit 14 which the companywide administrator 3 uses, and a companywide retrieval unit 15 which the user 5 uses for retrieving.

The division server 2 comprises a data mart 21 having data stored therein by divisions, a division information management dictionary 22 which is used for conducting various retrievals from the data mart 21, a division dictionary/data mart distribution unit 23 which is used for distributing a dictionary or data contents from the division server 2 to the other division server 2 or the companywide server 1 or acquiring the dictionary or the data contents from the companywide server 1 or the other division server 2, a division management unit 24 which each division administrator 4 uses, and a division retrieval unit 25 which each user uses for retrieving.

The companywide administrator 3 employs the companywide management unit 14 to conduct operation and management of the data warehouse 11 and the companywide information management dictionary 12 in the companywide server 1. For example, a tool function is used to conduct definition and-management of a scheme, a table or the like of data which is shared in a companywide manner. An accessible range is set with respect to each division so that a disclosure or non-disclosure can be set for each division. The dictionary/data mart distribution unit 13 can be used to duplicate updated data from the data warehouse 11 to the data mart 21 or reflect an updated portion of the companywide management dictionary 12 on the division information management dictionary 22.

The division administrators 4 each use the division management unit 24 to conduct operation and management of the data mart 21 and the division information management dictionary 22 in the division server 2. For example, the tool function is used to conduct definition and management of a scheme, a table or the like of data which is shared in the division. The division dictionary/data mart distribution unit 23 is used to duplicate data necessary for the data warehouse 11 or the other data mart 21 from the data mart 21 or to duplicate a part of the division information management dictionary 22 to the companywide information management dictionary 12.

These processings of the companywide administrator 3 and the division administrators 4 can be conducted by using an input device directly connected to the companywide server 1 and the division servers 2. However, these processings are generally conducted by using a processing device, an input device and a display device of each client terminal of the companywide administrator 3 and the division administrators 4 via a network.

The user 5 uses a user terminal comprising the processing device, the input device and the display device, and employs the companywide retrieval unit 15 or the division retrieval unit 25 to conduct retrieving the data warehouse 11 or the data mart 21 through the companywide information management dictionary 12 or the division information management dictionary 22. At this time, the user conducts selecting a retrieval condition by using a GUI which is displayed on the display device of his/her own terminal.

The data warehouse 11 and the companywide information management dictionary 12, and the data mart 21 and the division information management dictionary 22 belong to the companywide server 1 and the division server 2, respectively. However, except for an amount of data and a range which are managed, the data warehouse 11 and the data mart 21, and the companywide information management dictionary 12 and the division information management dictionary 22 have similar functions as a database and an information management dictionary, respectively.

Similarly, the companywide dictionary/data mart distribution unit 13 and the division dictionary/data mart distribution unit 23, the companywide management unit 14 and the division management unit 24, and the companywide retrieval unit 15 and the division retrieval unit 25 have similar functions as a dictionary/data mart distribution unit, a management unit, and a retrieval unit, respectively.

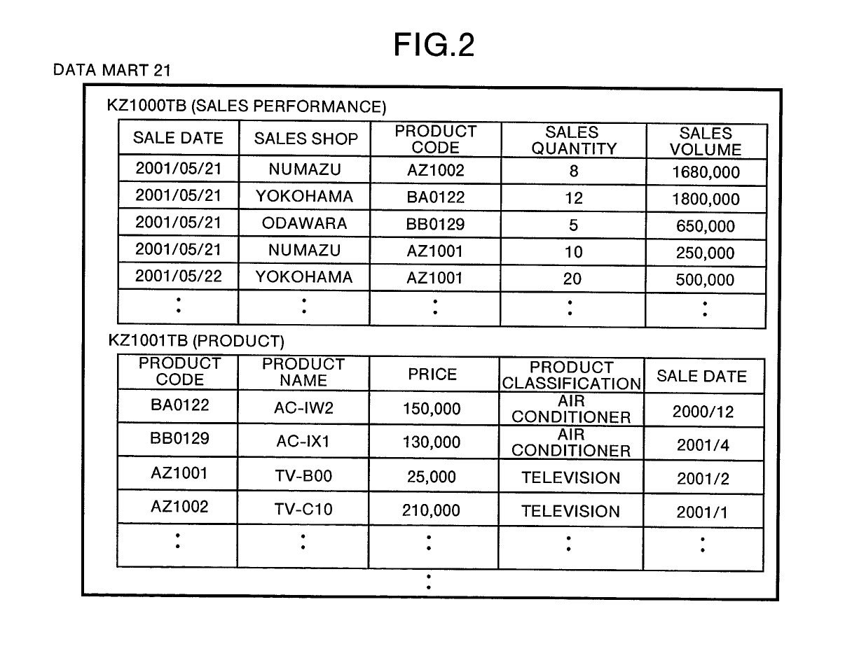

With reference to FIGS. 2 to 4, there will be explained a retrieval method of the user 5 with respect to the data mart 21. The following explanation of the embodiment will be given to a retrieval of data stored in the data mart 21, however, a retrieval with respect to data stored in the data warehouse 11 can be similarly conducted.

FIG. 2 is a view which shows an example of the data stored in the data mart 21 according to the present invention. There are stored various data such as a sales performance table (KZ1000TB) comprising data such as a sale date, a sales shop name, a product code, a product quantity, and a sales volume, or a product table (KZ1001TB) comprising data such as a product code, a product name, a price, a product classification, and a sale date in a table format. With a similar format, though not shown, there are stored various tables relevant to the divisions each having the data mart 21.

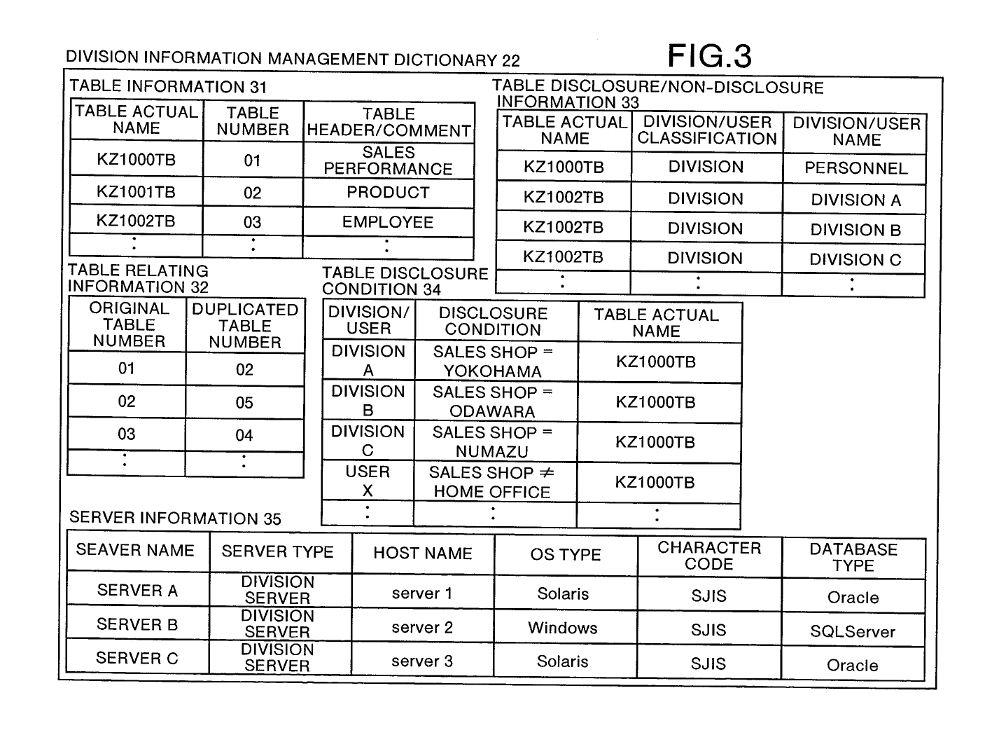

FIG. 3 is a view which shows examples of various tables which are managed with the division information management dictionary 22. Table information 31, table relating information 32, table disclosure/non-disclosure information 33, a table disclosure condition 34 and server information 35 are managed in the division information management dictionary 22.

The table information 31 is used for displaying an actual name (table actual name), a table number, and a header (or comment) of each table stored in the data mart 21 on the user terminal, where the table number, the header or comment corresponding to each table actual name are stored. The table actual name is denoted such that the division administrator 4 manages a table corresponding to a table header/comment.

The table relating information 32 stores the table numbers of relating tables among the respective tables stored in the data mart 21. For example, in the example of FIG. 3, information is managed in which a table 01 and a table 02 are related and a table 02 and a table 05 are related.

The table disclosure/non-disclosure information 33 stores a disclosure condition to determine to disclose what table by divisions or by users in the respective tables stored in the data mart 21, and to disclose to which division or which user. In FIG. 3, a division/user name which is non-disclosed in correspondence to the table actual name is managed. For example, the KZ1000TB table is non-disclosed to a personnel division, and a KZ1002TB table is non-disclosed to the divisions A, B, and C.

The disclosure condition managed with this table disclosure/non-disclosure information is determined by the division administrator. When the disclosure condition is disclosed to all the users, data is not set in this table disclosure/non-disclosure information 33. Therefore, a table in which a table actual name is not described in a list of the table disclosure/non-disclosure information 33 is disclosed to all the users.

The table disclosure condition 34 determines to manage the disclosure condition with respect to each data in each table stored in the data mart 21. In other words, it is determined which data in the table is disclosed to which user in the tables disclosed to each user. The example of FIG. 3 shows that only the data in which the sales shop is in Yokohama in the KZ1000TB table is disclosed to the division A, and that only the data in which the sales shop is in Odawara in the KZ1000TB table is disclosed to the division B. The disclosure condition is determined and managed by the division administrator 4 as in the case of the table disclosure/non-disclosure information 33.

The server information 35 is used for distributing (duplicating) information of the dictionary or the data mart to the companywide server 1 or the other division server 2 by using a division dictionary/data mart distribution unit 23.

In the server information 35, there are managed a server type of a distributed destination (companywide server or division server), a host name of the distributed destination server, an OS (Operating System) type of the distributed destination server, a character code type of the distributed destination server, and a database type of the distributed destination server in correspondence with the server name of the distributed destination.

Though not shown, in the information management dictionary 22, there are managed the attributes, the management points and the like of the schemes and the data items as in the prior art. The information management dictionary 22 has a portion of a personal dictionary managing information such as the management points created by an ordinary user.

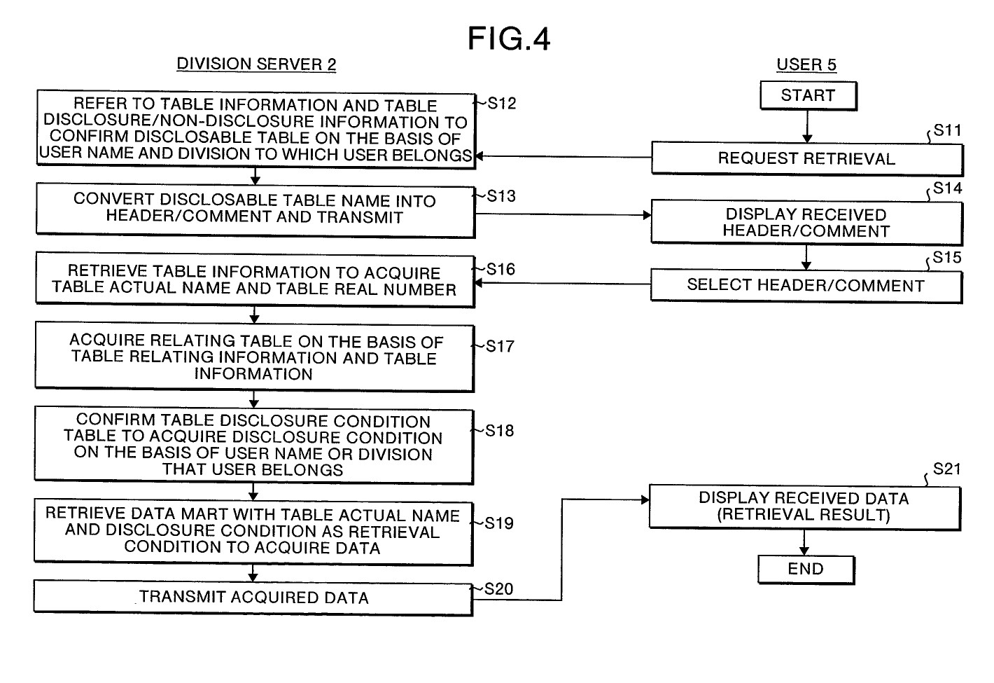

With reference to the flow chart in FIG. 4, there will be explained a method in which the user 5 retrieves the data mart 21 in the division server 2. This retrieval is conducted by employing a function of the division retrieval unit 25 in the division server 2.

At first, in step S11, the user 5 conducts a retrieval request with respect to the division server 2.

When the division server 2 receives the retrieval request, in step S12, the division server 2 refers to the table information 31 and the table disclosure/non-disclosure information 33 to confirm a disclosable table on the basis of a name of a user who has issued the retrieval request or a division to which the user belongs.

In step S13, the division server 2 converts the disclosable table name into the header/comment on the basis of the table information 31 to transmit it to the user 5.

When the user 5 receives the header/comment, in step S14, a table of the received header/comment is displayed on the display device of the terminal of the user 5.

In step S15, the user employs the GUI function to select a necessary header/comment.

In step S16, the division server 2 receives the selected header/comment, and retrieves the table information 31 to acquire the table actual name and the table number.

In step S17, on the basis of the table relating information 32 and the table information 31, the division server 2 acquires a relating table number and a relating table actual name.

In step S18, on the basis of the user name or the division to which the user belongs, the division server 2 confirms the table disclosure condition 34 to acquire the disclosure condition.

In step S19, with the table actual name and the disclosure condition as the retrieval condition, the division server 2 retrieves the data mart to acquire data.

In step S20, the division server 2 transmits the acquired data to the user 5.

When the user 5 receives the data, in step S21, the data of the retrieval result received in the display device of the terminal of the user 5 is displayed on the screen.

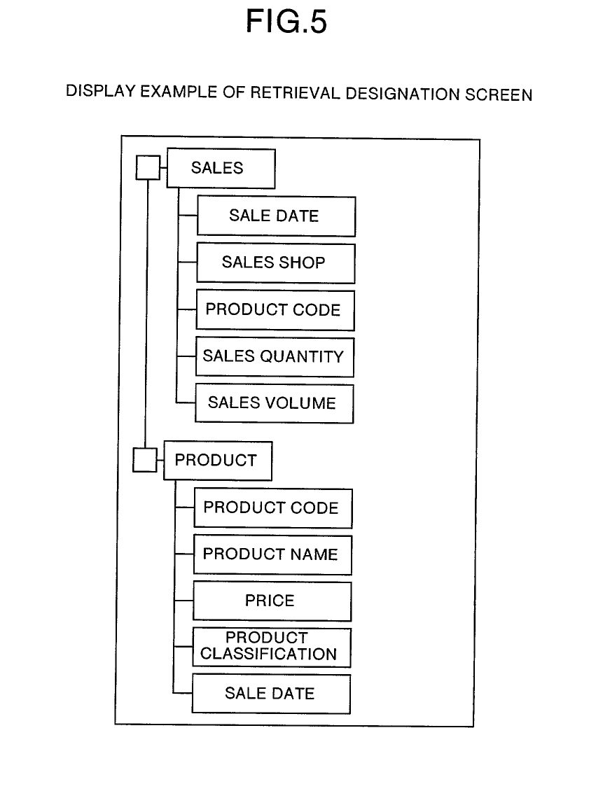

FIG. 5 is a display example of a retrieval designation screen displayed on the display device of the terminal of the user 5 in step S14. This display example shows an example displayed on each display device when the users of the division A and the division C request.

The table relevant to an employee in the KZ1002TB is non-disclosed to both the divisions A and C due to the table disclosure/non-disclosure information 33 so that the table is not displayed on the display screen.

As described above, the selectable range of the table may be limited according to the user so that the user can easily narrow to select the retrieval object which he/she wants.

In the present embodiment, the divisions (users) which are non-disclosed are managed with the table disclosure/non-disclosure information, conversely, the divisions (users) which are disclosed may be managed. Generally, many tables are disclosed, in many cases, some tables are non-disclosed so that it is easier to manage the tables which are non-disclosed.

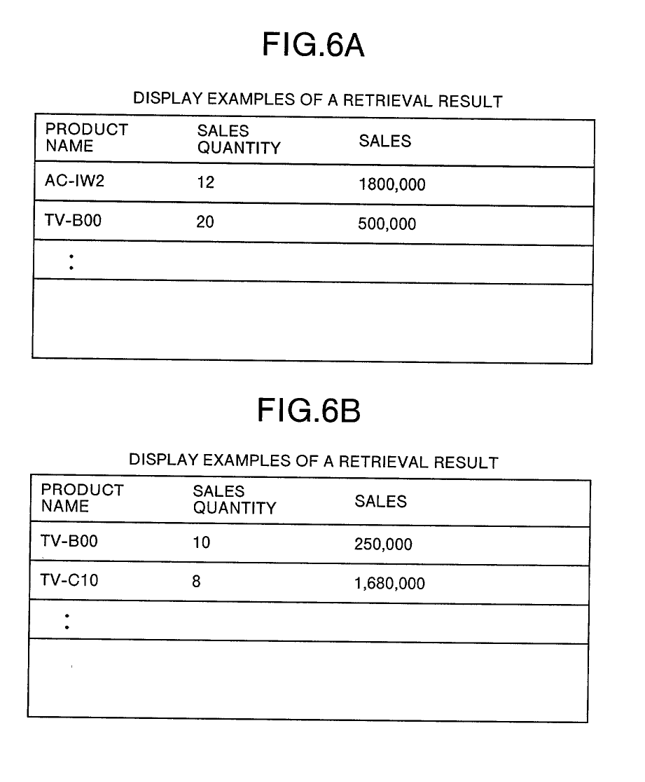

FIGS. 6A and 6B are display examples of the retrieval results displayed on the terminal of the user 5 in step S21, in which FIG. 6A shows the retrieval result of the division A and FIG. 6B shows the retrieval result of the division C.

With the table disclosure condition 34, data in which the sales shop is in Yokohama in the KZ1000TB with respect to the division A, and data in which the sales shop is in Numazu in the KZ1000TB with respect to the division C are retrieved from the data mart, respectively, and the results thereof are displayed on the respective screens.

As described above, with the table disclosure condition 34, the display range of the retrieval result is limited according to the user so that the data which should be disclosed to only the other users cannot be caused to be displayed and that the data unnecessary for the user who has conducted the retrieval request cannot be caused to be displayed.

The above explanation is given to the example of the retrieval with respect to the data mart 21 in the division server 2. However, the retrieval with respect to the data warehouse 11 in the companywide server 1 can also be conducted in a similar manner by employing the companywide information management dictionary 12 and the companywide retrieval unit 15. In other words, though not shown, as recorded in the division information management dictionary 22 described above in FIG. 3, there are recorded, in the companywide information management dictionary 12, the table information, the table disclosure/non-disclosure information, the table relating information, the table disclosure condition, and the server information.

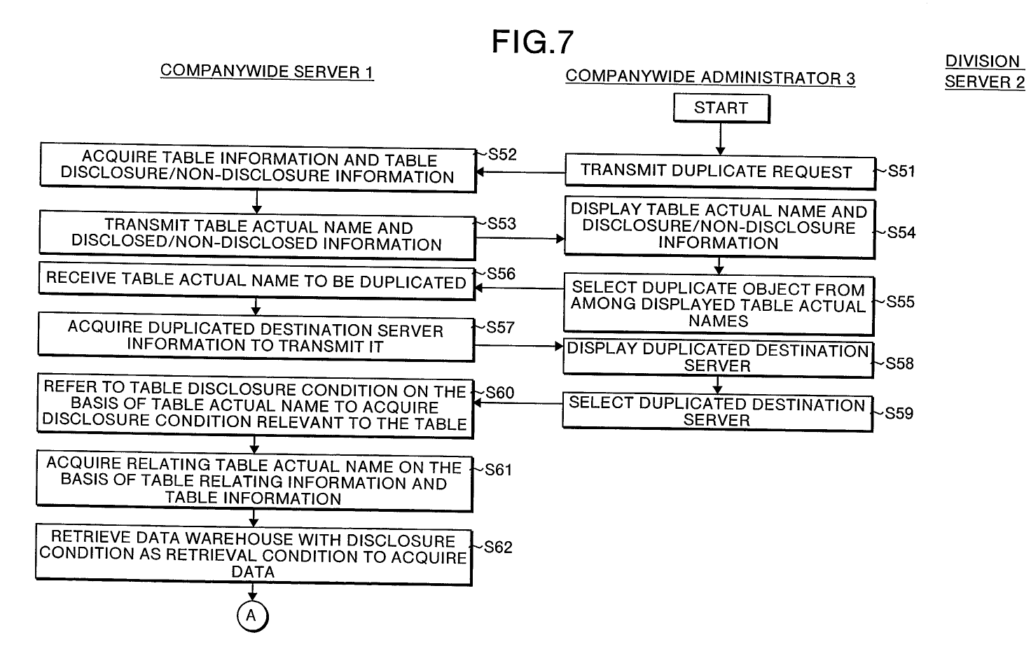

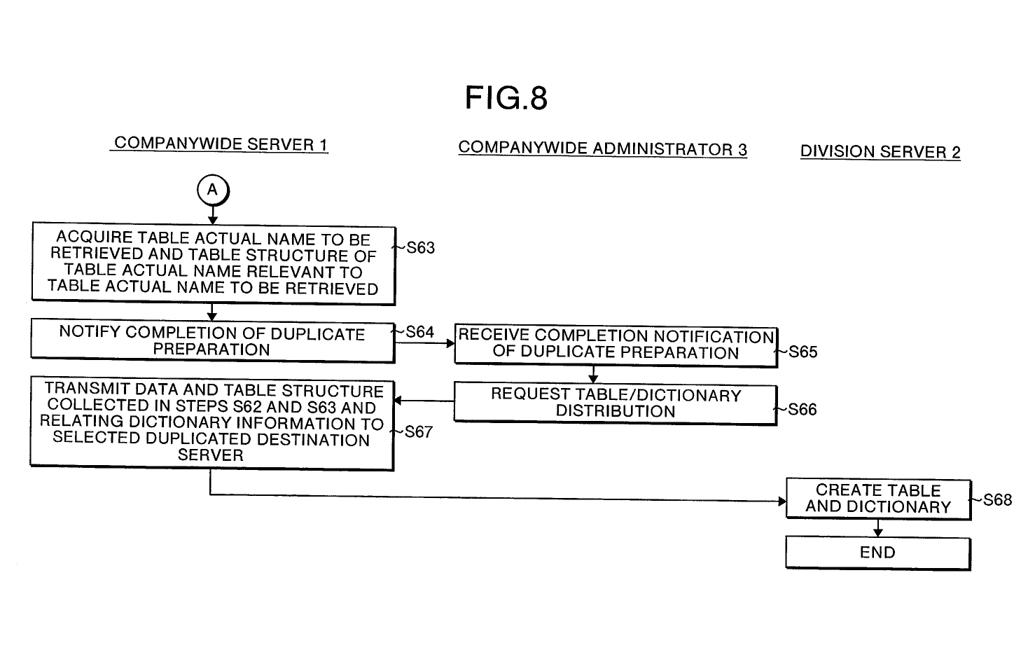

With reference to the flow charts in FIGS. 7 and 8, there will be explained a method in which the companywide administrator 3 duplicates the data of the data warehouse 11 and the data of the companywide information management dictionary 12 in the companywide server 1 into the data mart 21 and the division information management dictionary 22 in the division server 2. This duplicate is conducted by employing the functions of the companywide dictionary/data mart distribution unit 13 in the companywide server 1 and the division dictionary/data mart distribution unit 23 in the division server 2.

At first, in step S51, the companywide administrator 3 transmits a duplicate request to the companywide server.

Instep S52, the companywide server 1 which has received the duplicate request acquires the table information and the table disclosure/non-disclosure information in the companywide information management dictionary 12, on the basis of this information, in step S53, the companywide server 1 transmits the table actual name and the disclosure/non-disclosure information thereof to the companywide administrator 3.

When the companywide administrator 3 receives the table actual name and the disclosure/non-disclosure information thereof, in step S54, the disclosure/non-disclosure information thereof is displayed on the display device of the terminal of the companywide administrator 3. At this time, as described later, the disclosure/non-disclosure information is displayed in a manner that the table actual name can be determined to be disclosed or non-disclosed.

In step S55, the companywide administrator 3 employs the GUI function to select the table actual name which is to be duplicated from among the displayed tables.

In step S56, the companywide server 1 receives the selected table actual name (table actual name to be duplicated).

In step S57, with reference to the server information in the companywide information management dictionary, the companywide server 1 acquires information of the division server (in which the table corresponding to the table actual name is not non-disclosed) which is to be the duplicated destination to transmit the information to the companywide administrator 3.

When the companywide administrator 3 receives the information of the division server which is to be the duplicated destination, in step S58, the information including a server name which is the duplicated destination is displayed on the display device of the terminal of the companywide administrator 3.

In step S59, the companywide administrator 3 employs the GUI function to select a server which is to be the duplicated destination from among the displayed information of the division server.

In step S60, the companywide server 1 receives the server name of the selected duplicated destination, and on the basis of the table actual name relevant to the duplicated destination server, refers to the table disclosure condition to acquire the disclosure condition.

In step S61, on the basis of the table relating information and the table information in the companywide information management dictionary 12, the companywide server 1 acquires the table actual name relevant to the table actual name selected in step S55.

In step S62, with the table actual name and the disclosure condition as the retrieval condition, the companywide server 1 retrieves the data warehouse 11 to acquire the data to be duplicated.

In step S63, the companywide server 1 acquires a table structure (a data item name, a data type, a data length and the like in the table) of the table actual name to be retrieved and the table actual name relevant to the table actual name to be retrieved.

In step S64, the companywide server 1 notifies the terminal of the companywide administrator 3 of a completion of a duplicate preparation.

In step S65, when the companywide administrator 3 receives the completion notification of the duplicate preparation, in step S66, the companywide administrator 3 transmits a table/dictionary distribution request to the companywide server 1.

When the companywide server 1 receives the table/dictionary distribution request from the companywide administrator 3, in step S67, the companywide server 1 transmits the table or the data structure collected in steps S62 and S63, and the dictionary information such as the table disclosure/non-disclosure information, table disclosure condition and the table relating information relevant to the table to the duplicated destination server selected by the companywide administrator 3 in step S59.

When the division server 2 receives the information of the table or the dictionary from the companywide server 1, in step S68, the division server 2 creates (or updates) a table and a dictionary in the data mart 21 and the division information management dictionary 22.

When the table or the dictionary is newly created, the creation is conducted on the basis of the received data. However, when the relating table or dictionary already exists (or is updated) in the data mart 21 or the information management dictionary 22, only differential information relevant to the contents to be updated is transmitted so that the amount of data can be reduced.

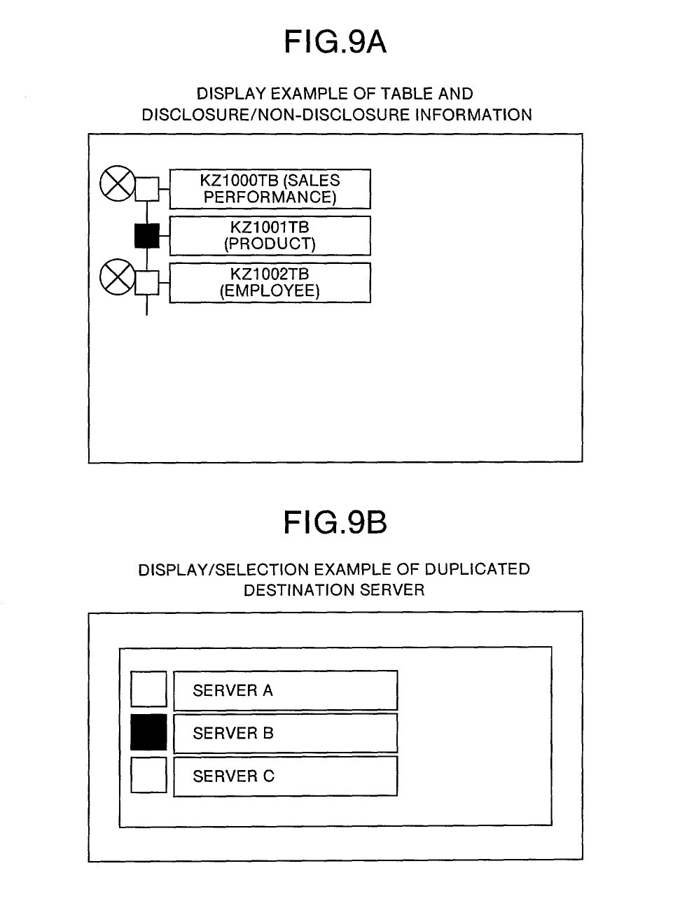

FIG. 9A is a display example of the table and the disclosure/non-disclosure information displayed on the terminal of the companywide administrator 3 in step S54. With reference to the table disclosure/non-disclosure information, the table such as the sales performance (KZ1000TB), the employee (KZ1001TB), or the like which has any non-disclosed information is denoted a mark of non-disclosure. On the other hand, the product (KZ1001TB) disclosed to all the users is not denoted with any mark. On the basis of the presence or absence of the mark, the companywide administrator 3 can know a disclosure or non-disclosure of the table.

In step S55, as a way to selectatable to be duplicated, as shown in this drawing, a mark can be formed in a check box (changed to a black square).

FIG. 9B is a display example of the duplicated destination server displayed on the display device of the terminal of the companywide administrator 3 in step S58. A server B is selected as the server to be the duplicated destination, and the check (black square) is formed in the check box. At this time, since the division server which is non-disclosed is not displayed, the companywide administrator 3 can select the duplicated destination without selecting the non-disclosed server as the duplicated destination.

The above description is given to an example in which the contents of the data warehouse 11 or the companywide information management dictionary 12 in the companywide server 1 are duplicated into the data mart 21 or the division information management dictionary 22 in the division server 2. However, in a similar manner, the duplicating may be conducted from the division server 2 to the companywide server 1, or between the division servers 2.

In this case, the division administrator 4 conducts duplicating by employing the function of the division dictionary/data mart distribution unit 23 and the function of the companywide dictionary/data mart distribution unit 13.

As described above, by employing the table disclosure/non-disclosure information 33 and the table disclosure condition 34, when the data of the data warehouse or the data mart or the contents of the information management dictionary is duplicated, only the information necessary for the duplicated destination division or user can be duplicated.

The duplicates of the data stored in the data warehouse or the data mart and the contents of the information management dictionary are not necessarily conducted at the same time, either one duplicate can be conducted.

In the above embodiment according to the present invention, in the retrieval of the data warehouse (or data mart), the table header/comment is transmitted to the user, and in the duplicate of the data or the information management dictionary, the table actual name is transmitted to the companywide administrator, which are conducted because, in many cases, the user generally conducts selecting with a header or a comment and the companywide administrator conducts managing with a table actual name, therefore, the transmission is not limited to these cases.

Therefore, it is possible to display the table header/comment to the company administrator or to display the table actual name to the user. In such a case, if necessary, it is possible to reduce the items of the table information or to arrange the table information and the table relating information.

Various units such as the companywide dictionary/data mart distribution unit 13, the companywide management unit 14, the companywide retrieval unit 15, the division dictionary/data mart distribution unit 23, the division management unit 24 and the division retrieval unit 25 in the companywide server 1 and the division server 2 described in the explanation of the embodiment according to the present invention can be obtained by installing a program into the computer such as the companywide server 1 or the division server 2 to function the program.

These programs can be caused to be transferred or distributed by employing a well-known computer readable and transportable recording medium such as a CD-ROM, a magneto-optical disk, a DVD-ROM or the like. These programs can be caused to be transferred or distributed by employing a transmitting medium through the network.

According to one aspect of this invention, an attribute or a management point of the data item for other users in the division which is originally unnecessary is not displayed so that it is possible to easily conduct selecting data according to a using range of the user.

According to another aspect of this invention, it is possible to easily conduct selecting data according to the using range of the user so that it is possible to disclose the specific data item to only the specific users.

Accordingly, when data in a database or contents of the information management dictionary which is used for retrieving is duplicated, it is possible to duplicate a part of the information management dictionary for a specific division or user or to bidirectionally duplicate the same. Therefore, it is possible to conduct duplicating only the information necessary for the division or user of the duplicated destination.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An information management dictionary into which management information of a table which is used for retrieving data from a database is stored, the information management dictionary comprising:
table disclosure/non-disclosure information for managing a user who conducts retrieving and disclosure or non-disclosure information of a table; and
a table disclosure condition for managing a disclosure condition of a user who conducts retrieving and each data in the table.

2. The information management dictionary according to claim 1, further comprising table relating information for managing information of a relating table among a plurality of the tables.

3. A server comprising:
a database having data stored therein; and
an information management dictionary into which management information of a table which is used for retrieving data from the database is stored,
wherein the information management dictionary includes
table disclosure/non-disclosure information for managing a user who conducts retrieving and disclosure or non-disclosure information of a table; and
a table disclosure condition for managing a disclosure condition of a user who conducts retrieving and each data in the table.

4. The server according to claim 3, wherein the information management dictionary further comprises table relating information for managing information of a relating table among a plurality of the tables.

5. The server according to claim 3, wherein the information management dictionary further comprises server information for managing information of another server.

6. The server according to claim 5, wherein the information of the another server includes at least one item of information among a server type, a host name, an OS type used for a server, a character code, and a database type.

7. The server according to claim 6, further comprising a dictionary/data mart distribution unit for distributing dictionary information and data to another server to duplicate the same.

8. A database retrieval method for retrieving data from a database by using a table, the database retrieval method comprising:
receiving a retrieval request from a user;
referring to table disclosure/non-disclosure information for managing a user and disclosure or non-disclosure information of a table to transmit to the user information of a table disclosed to the user;
receiving information of a table which is selected by the user in the transmitted information of the table;
referring to a table disclosure condition for managing a disclosure condition of a user and each data in a table on the basis of the information of the table to acquire a data item of the table disclosed to the user; and
retrieving the database on the basis of the data item of the table to transmit the acquired data to the user.

9. The database retrieval method according to claim 8, wherein the information of the table is a header or a comment of a table.

10. The database retrieval method according to claim 8, further comprising:
receiving information of a table which is selected by the user, and then acquiring information of other tables relevant to information of a table which is selected by the user on the basis of table relating information for managing information of a relating table among a plurality of tables; and
referring to a table disclosure condition for managing a disclosure condition of a user and each data item in a table on the basis of the information of the table and the information of the other tables to acquire data of the table which is disclosed to the user.

11. A database retrieval method for retrieving data from a database provided in the server by using a table, the database retrieval method comprising:
transmitting a retrieval request to a server;
receiving information of a table disclosable to the user from the server on the basis of table disclosure/non-disclosure information for managing a division to which the user belongs and a user stored in the server and disclosure or non-disclosure information of a table;
selecting to transmit the information of the table to the server; and
referring to a table disclosure condition for managing a disclosure condition of a user stored in the server and each data item in a table on the basis of the information of the table, and acquiring a data item of the table disclosed to the user to receive the data acquired by retrieving the database on the basis of the data item of the table from the server.

12. A data duplicate method for distributing data in a database provided in a server to the another server to duplicate the same, the data duplicate method comprising:
receiving a duplicate request from an administrator;
referring to table disclosure/non-disclosure information for managing a user and disclosure or non-disclosure information of a table to transmit table information and disclosure/non-disclosure information to the administrator;
receiving information of a table which is selected by the administrator in the transmitted information of the table and is to be duplicated;
receiving information of the another server which are each to be a duplicated destination from the administrator;
referring to a table disclosure condition for managing a disclosure condition of information of a table stored in the server and each data in a table to acquire data of the table disclosed to the another server which are each to be a duplicated destination from the database; and
transmitting the data of the table to the another server which are each to be the duplicated destination.

13. The data duplicate method according to claim 12, wherein the step of receiving information of the another server which each are to be a duplicated destination from the administrator comprises:
acquiring information of a duplicated destination server which distributes information of the table from server information for managing information of the another server;
transmitting the information of the another server to the administrator; and
receiving information of the another server which are selected by the administrator in the transmitted information of the another server and each are to be a duplicated destination.

14. The data duplicate method according to claim 12, wherein the step of acquiring data from the database on the basis of the information of the table comprises:
acquiring information of other tables relevant to the information of the table on the basis of table relating information for managing information of a relating table among a plurality of tables; and
referring to a table disclosure condition for managing a disclosure condition of information of a table stored in the server and each data in a table on the basis of the information of the table and the information of the other tables to acquire the table disclosed to the another server which each are to be the duplicated destination and the data of the other tables.

15. The data duplicate method according to claim 12, comprising the step of, when data in a database provided in a sever is distributed to the another server to be duplicated, duplicating at least one kind of information among table disclosure/non-disclosure information relevant to the another server, a table disclosure condition, table relating information, and information of the another server.

16. A computer program for causing a computer to execute the step of retrieving data from a database by using a table, comprising the steps of:
receiving a retrieval request from a user;
referring to table disclosure/non-disclosure information for managing a user and disclosure or non-disclosure information of a table to transmit to the user information of a table disclosed to the user;
receiving information of a table which is selected by the user in the transmitted information of the table;
referring to a table disclosure condition for managing a disclosure condition of a user and each data item in a table on the basis of the information of the table to acquire a data item of the table disclosed to the user; and
retrieving the database on the basis of the data item of the table to transmit the acquired data to the user.

17. A computer program for causing a computer to execute the step of distributing data in a database provided in a server to the another server to duplicate it, comprising the steps of:
receiving a duplicate request from an administrator;
referring to table disclosure/non-disclosure information for managing a user and disclosure or non-disclosure information of a table to transmit information of a table and disclosure/non-disclosure information to the administrator;
receiving information of a table which is selected by the administrator in the transmitted information of the table and is to be duplicated;
receiving information of the another server which each are to be a duplicated destination from the administrator;
referring to a table disclosure condition for managing a disclosure condition of information of a table stored in the server and each data in a table on the basis of the information of the table to acquire the data of the table disclosed to the another server which each are to be the duplicated destination from the database; and
transmitting the data of the table to the another server which each are to be the duplicated destination.

18. A recording medium for storing a computer program for causing a computer to execute retrieving data from a database by using a table stored therein, comprising the steps of:
receiving a retrieval request from a user;
referring to table disclosure/non-disclosure information for managing a user and disclosure or non-disclosure information of a table to transmit to the user information of a table disclosed to the user;
receiving information of a table which is selected by the user in the transmitted information of the table;
referring to a table disclosure condition for managing a disclosure condition of a user and each data item in a table on the basis of the information of the table to acquire the data item of the table disclosed to the user; and
retrieving the database on the basis of the data item of the table to transmit the acquired data to the user.

19. A recording medium for storing a computer program for causing a computer to execute distributing data in a database provided in a server to the another server to duplicate it stored therein, comprising the steps of:
receiving a duplicate request from an administrator;
referring to table disclosure/non-disclosure information for managing a user and disclosure or non-disclosure information of a table to transmit information of a table and disclosure/non-disclosure information to the administrator;
receiving information of a table which is selected by the administrator in the transmitted information of the table and is to be duplicated;
receiving information of the another server which each are to be a duplicated destination from the administrator;
referring to a table disclosure condition for managing a disclosure condition of information of a table stored in the server and each data in a table on the basis of the information of the table to acquire the data of the table disclosed to the another server from the database; and
transmitting the data of the table to the another server which each are to be the duplicated destination.
